(19) United States
(12) Patent Application Publication
(10) Pub. No.: US 2026/0121433 A1
(43) Pub. Date: Apr. 30, 2026

(54) BATTERY SYSTEM

(71) Applicant: TOYOTA JIDOSHA KABUSHIKI KAISHA, Toyota-shi (JP)

(72) Inventor: Masakazu HABU, Toyota-shi (JP)

(73) Assignee: TOYOTA JIDOSHA KABUSHIKI KAISHA, Toyota-shi (JP)

(21) Appl. No.: 19/349,228

(22) Filed: Oct. 3, 2025

(30) Foreign Application Priority Data
Oct. 29, 2024 (JP) 2024-189556

(51) Int. Cl. H02J 7/00; H02J 1/10

(52) U.S. Cl. CPC H02J 7/855; H02J 1/10; H02J 7/50; H02J 7/80; H02J 2207/20

(57) ABSTRACT

A battery system includes a plurality of battery packs connected to an external system, in parallel to each other, and a plurality of DC-to-DC converters. Each of the DC-to-DC converters includes a step-up circuit that steps up direct current voltage of the corresponding battery pack and outputs stepped-up voltage to the external system, and a voltage detector that detects the stepped-up voltage. In the correction mode, the control device controls the step-up circuit of a first DC-to-DC converter that is selected from the DC-to-DC converters, while stopping operation of the step-up circuits of the remaining DC-to-DC converters. The control device corrects the voltage detector of at least one DC-to-DC converter from among the DC-to-DC converters, based on detected values of the voltage detectors of the DC-to-DC converters.

### CROSS-REFERENCE TO RELATED APPLICATION

This application claims priority to Japanese Patent Application No. 2024-189556 filed on October 29, 2024. The disclosure of the above-identified application, including the specification, drawings, and claims, is incorporated by reference herein in its entirety.

### BACKGROUND

### 1. Technical Field

The present disclosure relates to a battery system, and more particularly to technology for correcting a voltage detector that is disposed in a battery system that is configured including a plurality of step-up circuits.

### 2. Description of Related Art

Japanese Unexamined Patent Application Publication No. 2010-259265 (JP 2010-259265 A) discloses an automobile that is equipped with a first battery and a second battery that are connected in parallel to a drive circuit that drives an electric motor, and a first step-up circuit and a second step-up circuit that is provided corresponding to the first battery and the second battery, respectively, for stepping up voltage of the corresponding batteries and performing supplying thereof to the drive circuit.

The automobile further includes a first system main relay that connects/disconnects the first battery and the first step-up circuit, a second system main relay that connects/disconnects the second battery and the second step-up circuit, a voltage detector that detects the voltage on the second battery side of the second step-up circuit, and an abnormality determination unit that determines abnormalities in the second step-up circuit. The abnormality determination unit determines that an abnormality has occurred in which a transistor making up an upper arm of the second step-up circuit is stuck on, when a detected value of the voltage detector is equal to or greater than a threshold value in a state in which the first system main relay is turned on and the second system main relay is turned off.

### SUMMARY

In a configuration having a plurality of step-up circuits, such as in the automobile that is described in JP 2010-259265 A, a voltage detector is generally provided for each step-up circuit to detect stepped-up voltage, which is the voltage after stepping up. Accordingly, the entire battery system is configured with a plurality of voltage detectors disposed therein. When an error occurs in the outputs of the voltage detectors, there is concern that the stepped-up voltage cannot be accurately controlled. Thus, it is important to perform correction for the voltage detectors. However, JP 2010-259265 A makes no mention of correcting the voltage detectors.

The present disclosure has been made to solve such problems, and an object of the present disclosure is to correct a plurality of voltage detectors in a battery system including a plurality of battery packs connected in parallel and a plurality of voltage detectors that detects stepped-up voltages of a plurality of step-up circuits provided corresponding to each of the battery packs, respectively.

According to one aspect of the present disclosure, a battery system regarding which charging and discharging between the battery system and an external system is performed includes a plurality of battery packs connected the external system, in parallel to each other, a plurality of DC-to-DC converters, and a control device that controls the DC-to-DC converters. The DC-to-DC converters are provided corresponding to the battery packs, respectively, each of which performs direct current voltage conversion between a corresponding battery pack and the external system. Each of the DC-to-DC converters includes a step-up circuit that steps up direct current voltage of the corresponding battery pack and outputs a stepped-up voltage, which is voltage after stepping up, to the external system, and a voltage detector for detecting the stepped-up voltage.

The battery system is configured to execute a normal operation mode in which charging and discharging is performed between the battery system and the external system, and a correction mode in which the voltage detector is corrected. In the normal operation mode, the control device controls the step-up circuit for each of the DC-to-DC converters using a detected value of the voltage detector. In the correction mode, the control device controls the step-up circuit of a first DC-to-DC converter that is selected from the DC-to-DC converters, while stopping operation of the step-up circuits of the remaining DC-to-DC converters. During control of the step-up circuit of the first DC-to-DC converter, the control device corrects the voltage detector of at least one DC-to-DC converter from among the DC-to-DC converters, based on the detected values of the voltage detectors of the DC-to-DC converters.

According to this configuration, a plurality of voltage detectors, which detects the stepped-up voltage of a plurality of step-up circuits, can be corrected, respectively. Correcting the voltage detectors reduces detection error of the voltage detectors, thereby suppressing error in the electric power that is charged and discharged to and from the corresponding battery pack. Accordingly, there is no need to increase scale of wiring in wiring design of the battery system.

Preferably, during control of the step-up circuit of the first DC-to-DC converter, the control device estimates a true value of the stepped-up voltage in the step-up circuit of the first DC-to-DC converter based on the detected values of the voltage detectors of the DC-to-DC converters. The control device uses the true value that is estimated to correct the voltage detector of the at least one DC-to-DC converter.

According to this configuration, the detection error of this voltage detector is found from difference between the true value that is estimated and the detected value of the voltage detector. A correction value for the voltage detector is then calculated based on the detection error that is found, and accordingly the detected value of this voltage detector can be corrected in accordance with the correction value.

Preferably, the external system includes a power conversion device that performs bidirectional electric power conversion between a power grid and the battery system. The control device executes the correction mode during shutdown of the power conversion device.

According to this configuration, correction of the voltage detector can be performed by utilizing a time period in which the battery system is neither charging nor discharging between the battery system and the external system.

Preferably, in the normal operation mode, the control device executes droop control of the step-up circuit in each of the DC-to-DC converters, based on the detected value of the voltage detector.

According to this configuration, detection errors of the voltage detector are reduced, and accordingly error in the electric power charged to and discharged from the corresponding battery pack during droop control is suppressed.

According to the present disclosure, a plurality of voltage detectors can be corrected in a battery system including a plurality of battery packs connected in parallel and the voltage detectors that detect stepped-up voltages of a plurality of step-up circuits, provided corresponding to each of the battery packs, respectively.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery system according to an embodiment of the present disclosure;

FIG. 2 is a diagram illustrating a configuration of a battery module;

FIG. 3 is a diagram for describing a correction mode of the battery system; and

FIG. 4 is a flowchart for describing procedures of correction processing of a voltage detector by a control device.

### DETAILED DESCRIPTION OF EMBODIMENTS

An embodiment of the present disclosure will be described in detail below with reference to the drawings. Note that the same or equivalent portions in the drawings are denoted by the same reference symbols, and description of such portions will not be repeated.

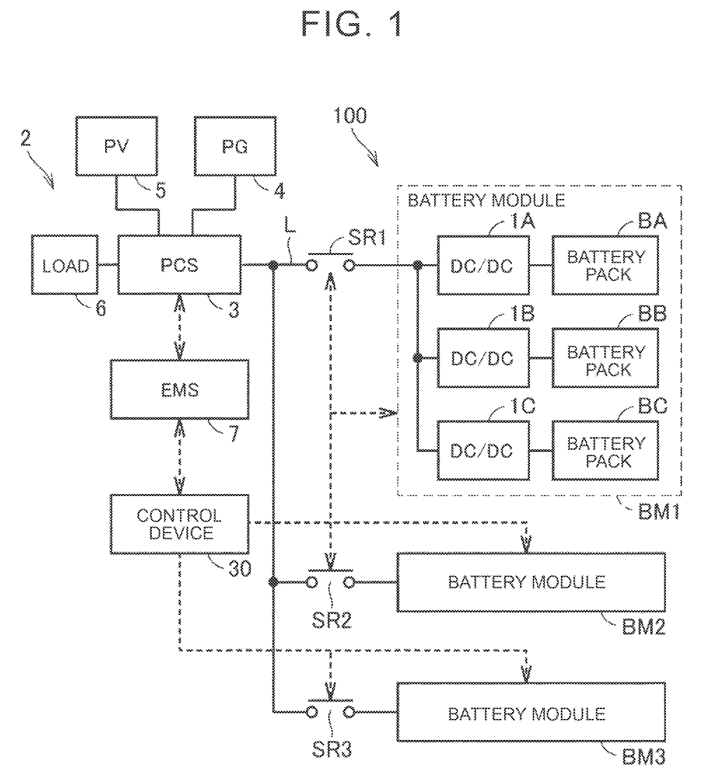

FIG. 1 is a schematic configuration diagram of a battery system according to the embodiment of the present disclosure. As illustrated in FIG. 1, a battery system 100 according to the present embodiment is connected to an external system 2 via a power line L. The battery system 100 can receive power feed from the external system 2, and can also discharge power to the external system 2. The battery system 100 is applied to, for example, a stationary power storage system that is installed in premises of a consumer.

The battery system 100 includes a plurality of battery modules BM1 to BM3, a plurality of sub-relays SR1 to SR3, and a control device 30. Hereinafter, the battery modules BM1 to BM3 will also be collectively referred to as "battery modules BM," and the sub-relays SR1 to SR3 will also be collectively referred to as "sub-relays SR". In the example in FIG. 1, the battery system 100 includes three battery modules BM and three sub-relays SR, but the number of each of the battery modules BM and the sub-relays SR is optional, and may be singular.

The battery modules BM1 to BM3 are connected to the external system 2, in parallel to each other. The sub-relays SR1 to SR3 are provided corresponding to the battery modules BM1 to BM3, respectively. The sub-relays SR are controlled by the control device 30 to connect or disconnect the corresponding battery modules BM and the external system 2. In one scenario, when the battery system 100 is started up, the sub-relays SR are turned on, and corresponding battery modules BM are connected to the external system 2. When a malfunction occurs in the corresponding battery module BM during operation of the battery system 100, the sub-relay SR is turned off and the corresponding battery module BM is disconnected from the external system 2.

The battery module BM1 includes a plurality of battery packs BA to BC and a plurality of direct current (DC)-to-DC converters 1A to 1C. Hereinafter, the battery packs BA to BC will also be collectively referred to as "battery pack B", and the DC-to-DC converters 1A to 1C will also be collectively referred to as "DC-to-DC converter 1". In the example in FIG. 1, the battery module BM1 includes three battery packs B and three DC-to-DC converters 1, but it is sufficient for the number of each of the battery packs B and the DC-to-DC converters 1 to be plural.

The battery packs BA to BC are connected to the external system 2 via the sub-relay SR1, in parallel to each other. Each of the battery packs B includes a battery stack.

The DC-to-DC converters 1A to 1C are provided corresponding to the battery packs BA to BC, respectively. The DC-to-DC converters 1 control charging and discharging of the corresponding battery packs B by executing direct current voltage conversion between the corresponding battery pack B and the external system 2. Specifically, each of the DC-to-DC converters 1 is configured including a step-up circuit and a step-down circuit. The step-up circuit steps up direct current voltage of the corresponding battery pack B and outputs stepped-up voltage, which is the voltage after stepping up, to the external system 2, thereby controlling discharging of the corresponding battery pack B. The step-down circuit steps down direct current voltage from the external system 2 and outputs stepped-down voltage, which is the voltage after stepping down, to the corresponding battery pack B, thereby controlling charging of the corresponding battery pack B. The step-up circuit and the step-down circuit are realized by, for example, a bidirectional chopper.

Although omitted from illustration, the configuration of each of the battery modules BM2 and BM3 is the same as the configuration of the battery module BM1.

The external system 2 is configured including a power conditioning system (PCS) 3, a power grid (PG) 4, a photovoltaic power generation system (PV) 5, a load 6, and an energy management system (EMS) 7. The PCS 3 includes a power conversion device that is capable of both alternating current (AC)-to-DC conversion, and DC-to-AC conversion. The PCS 3 converts, for example, direct current electric power from the photovoltaic power generation system 5 or the battery system 100 into alternating current electric power, and performs supply thereof to the load 6. The load 6 is an electrical appliance that is installed in premises of a consumer, such as for example, an air conditioner, a lighting fixture, or the like. The PCS 3 transmits and receives alternating current electric power to and from the power grid 4. The power grid 4 is not limited to a large-scale power grid that is maintained as an infrastructure, and may be a microgrid.

The EMS 7 collaborates with the PCS 3 to manage a state of energy usage in the premises of the consumer. The EMS 7 includes home EMSs (HEMS), building EMSs (BEMS), factory EMSs (FEMS), and so forth. The EMS 7 includes a processor and memory.

The control device 30 includes a processor and memory, and controls the battery system 100 under commands that are received from the EMS 7. Specifically, the control device 30 controls the sub-relays SR1 to SR3, and also controls the DC-to-DC converters 1A to 1C in each of the battery modules BM, respectively.

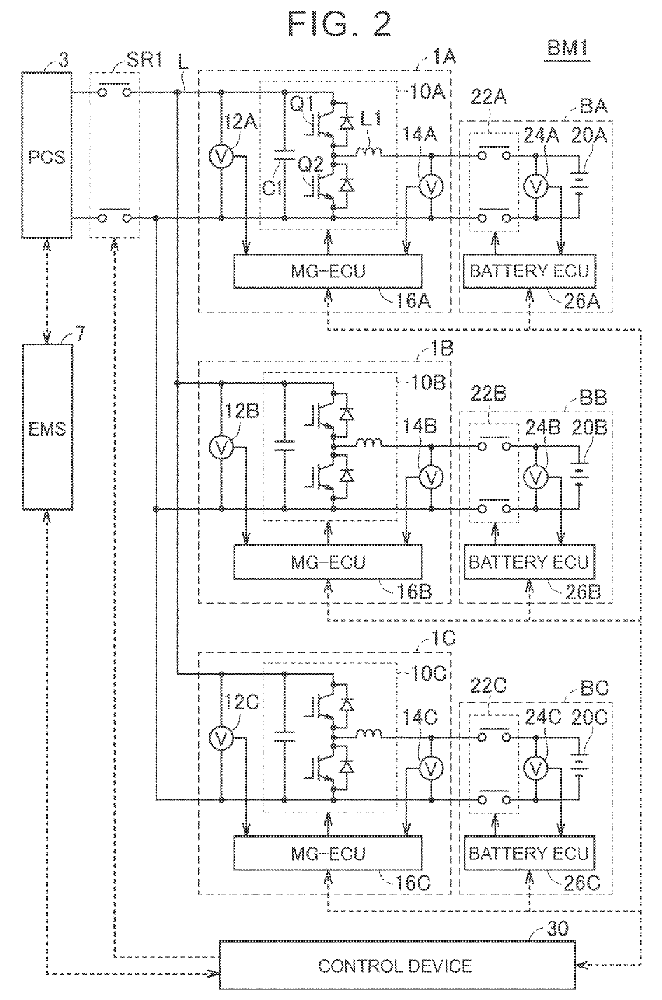

FIG. 2 is a diagram illustrating a configuration of the battery module BM. FIG. 2 representatively illustrates a configuration of the battery module BM1. As illustrated in FIG. 2, the DC-to-DC converter 1A includes a bidirectional chopper 10A, voltage detectors 12A and 14A, and a motor generator electronic control unit (MG ECU) 16A. The DC-to-DC converter 1B includes a bidirectional chopper 10B, voltage detectors 12B and 14B, and an MG ECU 16B. The DC-to-DC converter 1C includes a bidirectional chopper 10C, voltage detectors 12C and 14C, and an MG ECU 16C. Hereinafter, the bidirectional choppers 10A to 10C will also be collectively referred to as "bidirectional choppers 10", the voltage detectors 12A to 12C will also be collectively referred to as "voltage detectors 12", and the voltage detectors 14A to 14C will also be collectively referred to as "voltage detectors 14".

The bidirectional chopper 10 is a well-known device that includes a plurality of semiconductor switching devices. In the example in FIG. 2, each of the bidirectional choppers 10 includes a reactor L1 as an energy storage element, two semiconductor switching devices Q1 and Q2 that are connected in series, and a smoothing capacitor C1. The bidirectional chopper 10 steps up the direct current voltage of the corresponding battery pack B, and outputs the stepped-up voltage, which is the voltage after stepping up, to the external system 2 via the power line L. The bidirectional chopper 10 corresponds to an embodiment of "step-up circuit". Also, the bidirectional chopper 10 steps down the direct current voltage from the external system 2, and outputs the stepped-down voltage, which is the voltage after stepping down, to the corresponding battery pack B.

The voltage detector 14 detects the voltage (the direct current voltage of the battery pack B) before stepping up by the bidirectional chopper 10, and outputs a signal indicating a detected value. The voltage detector 12 detects the stepped-up voltage, which is the voltage after stepping up by the bidirectional chopper 10, and outputs a signal indicating the detected value.

The MG ECU 16 is a device that controls communication between the bidirectional chopper 10 and the control device 30, and includes a processor and memory. Each of the MG ECUs 16 transmits output signals of the voltage detectors 12 and 14 to the control device 30. Also, the MG ECU 16 receives a control signal for controlling the bidirectional chopper 10 from the control device 30. The bidirectional chopper 10 executes direct current voltage conversion in accordance with a control signal from the control device 30.

The battery pack BA includes a battery stack 20A, a relay 22A, a voltage detector 24A, and a battery ECU 26A. The battery pack BB includes a battery stack 20B, a relay 22B, a voltage detector 24B, and a battery ECU 26B. The battery pack BC includes a battery stack 20C, a relay 22C, a voltage detector 24C, and a battery ECU 26C. Hereinafter, the battery stacks 20A to 20C will also be collectively referred to as "battery stacks 20", and the relays 22A to 22C will also be collectively referred to as "relays 22". The voltage detectors 24A to 24C will also be collectively referred to as "voltage detectors 24", and the battery ECUs 26A to 26C will also be collectively referred to as "battery ECUs 26".

Each of the battery stacks 20 is an assembled battery in which a plurality of single batteries (battery cells) is connected in series, for example. The battery cells may be, for example, ternary lithium-ion batteries, or may be iron phosphate lithium-ion batteries. The battery cells may also be nickel metal hydride batteries. The battery pack B may be a repurposed battery pack that was installed in an electrified vehicle. The battery pack B may include a single cell instead of the assembled battery.

Each of the relays 22 is controlled by the battery ECU 26 to connect or disconnect the battery stack 20 and the DC-to-DC converter 1.

Each of the voltage detectors 24 detects the voltage of the battery stack 20, and outputs a signal indicating the detected value. Each of the battery packs B is further provided with, in addition to the voltage detector 24, a current detector for detecting the current flowing through the battery stack 20, and a temperature detector for detecting the temperature of the battery stack 20, although omitted from illustration.

Each of the battery ECUs 26 includes a processor and memory, and monitors the corresponding battery stack 20. The battery ECU 26 transmits output signals from the voltage detector 24, the current detector, and the temperature detector, to the control device 30. Also, the battery ECU 26 calculates a State Of Charge (SOC) of the battery stack 20, based on the output signals of the voltage detector 24 and the current detector, and transmits a signal indicating the SOC that is calculated to the control device 30. Also, the battery ECU 26 controls the relay 22 in accordance with control signals that are provided from the control device 30.

Next, operation of the battery system 100 according to the present embodiment will be described.

The battery system 100 according to the present embodiment has a normal operation mode in which charging and discharging is performed between the battery system 100 and the external system 2, and a correction mode for correcting the voltage detectors 12A to 12C.

In the normal operation mode, the control device 30 receives commands from the EMS 7 and controls the battery modules BM1 to BM3. In the present embodiment, the control device 30 executes droop control in each battery module BM. Specifically, the control device 30 controls the charging and discharging of the corresponding battery pack B in each of the multiple DC-to-DC converters 1A to 1C such that the stepped-up voltage, which is voltage after stepping up by each of the bidirectional choppers 10, matches a target voltage.

In one scenario, the control device 30 calculates, for each DC-to-DC converter 1, voltage deviation between a target voltage and a detected value of the stepped-up voltage detected by the voltage detector 12. The control device 30 then determines the electric power to be charged to the corresponding battery pack B, and the electric power to be discharged from the corresponding battery pack B, in proportion to the voltage deviation that is calculated.

Note that in a case in which any one of the battery packs BA to BC in the battery module BM1 malfunctions while the normal operation mode is being executed, the control device 30 disconnects the battery module BM1 from the external system 2 by turning off the sub-relay SR1.

In this way, in the normal operation mode, droop control is performed in each of the DC-to-DC converters 1A to 1C, and the charging and discharging of the corresponding battery pack B is controlled such that the stepped-up voltage matches the target voltage. However, the stepped-up voltages of the DC-to-DC converters 1A to 1C do not necessarily match, due to differences in the currents flowing from the battery packs BA to BC, control variance among the bidirectional choppers 10A to 10C, and so forth. Accordingly, in the normal operation mode, comparing the detected values of the voltage detectors 12A to 12C with each other does not enable the voltage detectors 12A to 12C to be corrected.

Accordingly, in the present embodiment, a correction mode is provided for correcting the voltage detectors 12A to 12C. Either the normal operation mode or the correction mode is then selected depending on the state of energy usage in the premises of the consumer. In one scenario, a user (consumer) of the battery system 100 can select either the normal operation mode or the correction mode. In this case, the user can perform an operation on the EMS 7 to select the correction mode during a time period when neither charging nor discharging is being performed between the battery system 100 and the external system 2. Upon accepting this operation, the EMS 7 stops the operation of the PCS 3, thereby stopping the charging and discharging of the battery system 100.

During shutdown of the PCS 3, the control device 30 executes the correction mode. In the correction mode, the control device 30 selects one battery module BM from the battery modules BM1 to BM3 as an object of correction. The control device 30 stops the operation of the DC-to-DC converters 1A to 1C in the battery modules BM that have not been selected as objects of correction.

Note that during the correction mode, the control device 30 maintains all of the sub-relays SR1 to SR3 in an on state. This is because in a configuration in which the sub-relay SR corresponding to the battery module BM that is the object of correction is turned off during the correction mode, and then the sub-relay SR is turned on after the correction mode ends, an overcurrent due to the difference in stepped-up voltage between the battery modules BM1 to BM3 flows when the sub-relay SR is turned on, which may cause fusing of the sub-relay SR.

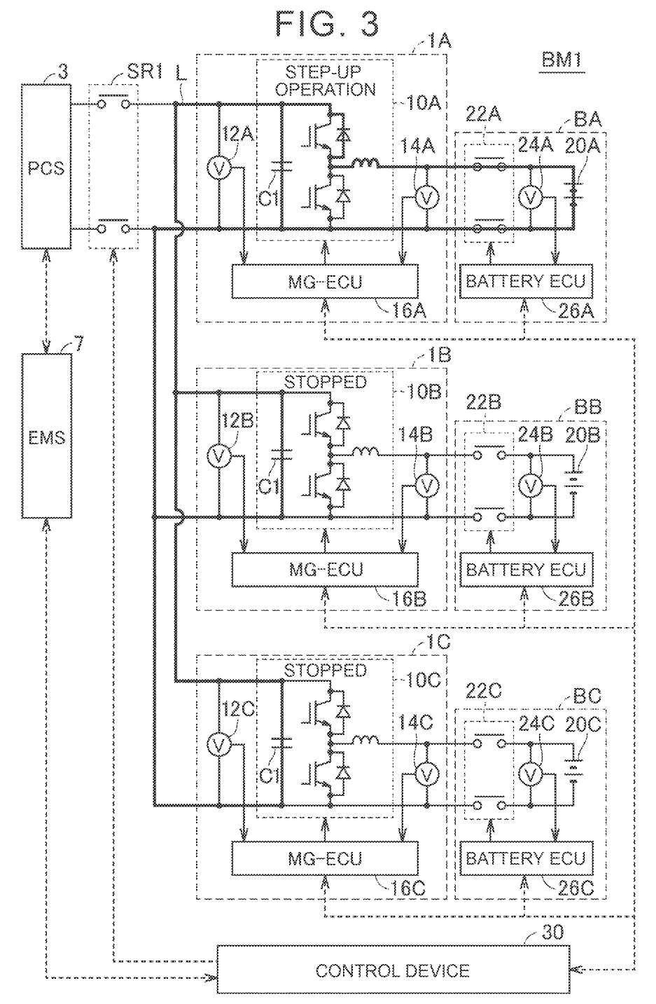

FIG. 3 is a diagram for describing the correction mode of the battery system 100. In FIG. 3, the battery module BM1 is selected as the object of correction. The battery modules BM2 and BM3 that were not selected as objects of correction are omitted from illustration.

As illustrated in FIG. 3, in the correction mode, the control device 30 selects one DC-to-DC converter 1 from among the DC-to-DC converters 1A to 1C that are included in the battery module BM1 that is the object of correction. In the example of FIG. 3, the control device 30 selects the DC-to-DC converter 1A. The DC-to-DC converter 1A that is selected corresponds to "first DC-to-DC converter".

Next, the control device 30 controls the bidirectional chopper 10A of the DC-to-DC converter 1A that is selected. On the other hand, the control device 30 stops the operation of the bidirectional choppers 10B and 10C of the remaining DC-to-DC converters 1B and 1C that are not selected.

The bidirectional chopper 10A is controlled by the control device 30 so as to step up the direct current voltage of the battery pack BA, and output the stepped-up voltage, which is the voltage after stepping up, to the power line L. The voltage detector 12A detects the stepped-up voltage of the bidirectional chopper 10A, and outputs a signal indicating the detected value.

As indicated by a heavy continuous line in FIG. 3, the stepped-up voltage of the bidirectional chopper 10A is applied to the capacitor C1 of the bidirectional chopper 10B via the power line L. The voltage detector 12B detects voltage across the terminals of the capacitor C1, and outputs a signal indicating the detected value. That is to say, the voltage detector 12B detects the stepped-up voltage of the bidirectional chopper 10A.

Similarly, the stepped-up voltage of the bidirectional chopper 10A is applied to the capacitor C1 of the bidirectional chopper 10C via the power line L. The voltage detector 12C detects the voltage across the terminals of the capacitor C1, and outputs a signal indicating the detected value. That is to say, the voltage detector 12C detects the stepped-up voltage of the bidirectional chopper 10A.

When all of the voltage detectors 12A to 12C are normal, the detected value of the voltage detector 12A, the detected value of the voltage detector 12B, and the detected value of the voltage detector 12C match each other. Conversely, when at least one of the voltage detectors 12A to 12C is faulty, the detected value of the voltage detector 12A, the detected value of the voltage detector 12B, and the detected value of the voltage detector 12C will not match. For example, when one voltage detector 12 among the voltage detectors 12A to 12C is faulty and the remaining two voltage detectors 12 are normal, two of the three detected values will match, and the one remaining detected value will not match these two detected values.

Upon receiving the output signals of the voltage detectors 12A to 12C, the control device 30 corrects the voltage detectors 12 using the detected values of the voltage detectors 12A to 12C. Specifically, the control device 30 first estimates a true value of the stepped-up voltage in the bidirectional chopper 10A of the DC-to-DC converter 1 (first DC-to-DC converter) by comparing the detected values of the voltage detectors 12A to 12C. For example, the control device 30 estimates the true value of the stepped-up voltage of the bidirectional chopper 10A by a majority vote of the detected values of the voltage detectors 12A to 12C. As described above, when one voltage detector 12 among the voltage detectors 12A to 12C is faulty and the remaining two voltage detectors 12 are normal, two detected values of the three detected values will match, and the remaining one detected value will not match these two detected values. In this case, the control device 30 estimates that the two matching detected values are the true value of the stepped-up voltage of the bidirectional chopper 10A.

Next, the control device 30 corrects at least one voltage detector 12 using the estimated true value of the stepped-up voltage. In the case described above, the control device 30 corrects the voltage detector 12 that outputs the remaining one detected value. Specifically, the control device 30 takes the difference between the remaining one detected value, and the true value of the stepped-up voltage that is estimated, as being the detection error of the voltage detector 12, and calculates a correction value for this voltage detector 12 based on this detection error. Following the correction mode ending, the detected value of the voltage detector 12 is corrected according to the above correction value, and thus the stepped-up voltage of the corresponding bidirectional chopper 10 is detected.

Note that the technique for estimating the true value of the stepped-up voltage in the bidirectional chopper 10 is not limited to majority voting, and known statistical processing can be used. For example, the true value of the stepped-up voltage in the bidirectional chopper 10 can be estimated from an average value and standard deviation of the detected values of a plurality of the voltage detectors 12.

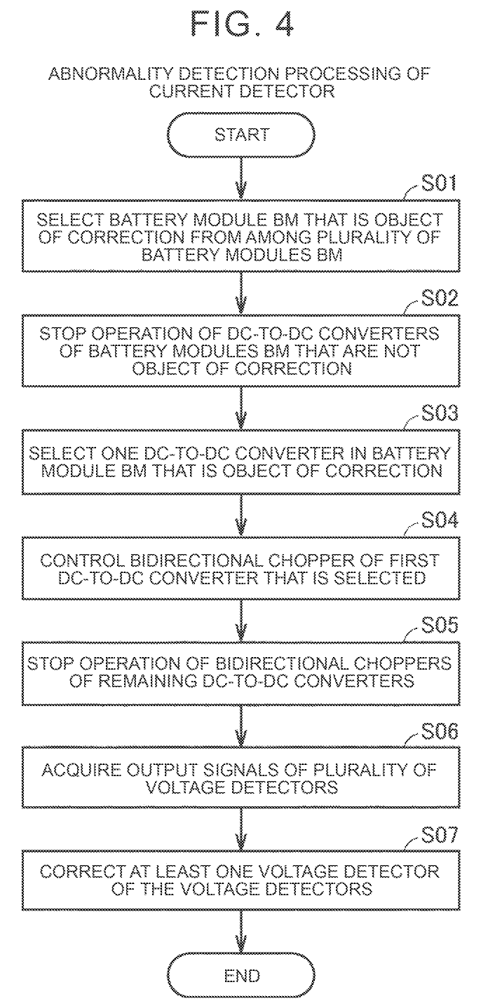

FIG. 4 is a flowchart for describing procedures of correction processing of the voltage detectors 12 by the control device 30. As described above, the correction processing of the voltage detectors 12 is executed during shutdown of the PCS 3.

As shown in FIG. 4, in step S01 the control device 30 selects one battery module BM to be the object of correction, from among the battery modules BM1 to BM3 that are included in the battery system 100. In step S02, the control device 30 further stops operation of the DC-to-DC converters 1A to 1C in the battery modules BM that have not been selected as objects of correction. Note that during the correction mode, the control device 30 maintains all of the sub-relays SR1 to SR3 in the on state.

In step S03, the control device 30 selects one DC-to-DC converter 1 (first DC-to-DC converter) from among the DC-to-DC converters 1A to 1C in the battery module BM that is the object of correction.

Next, in step S04, the control device 30 controls the bidirectional chopper 10 of the DC-to-DC converter 1 that is selected. The bidirectional chopper 10 is controlled by the control device 30 to step up the direct current voltage of the corresponding battery pack B, and output the stepped-up voltage to the power line L. The voltage detector 12 detects the stepped-up voltage of the bidirectional chopper 10, and outputs a signal indicating the detected value.

In step S05, the control device 30 stops operation of the bidirectional choppers 10 of the remaining DC-to-DC converters 1 that have not been selected in the battery module BM that is the object of correction. In each of the remaining DC-to-DC converters 1, the voltage detector 12 detects the voltage that is applied to the capacitor C1 of the bidirectional chopper 10 via the power line L, and outputs a signal indicating the detected value. That is to say, the voltage detector 12 detects the stepped-up voltage of the bidirectional chopper 10 of the first DC-to-DC converter 1.

In step S06, the control device 30 obtains signals indicating the detected values of the stepped-up voltages of the bidirectional choppers 10 from the voltage detectors 12A to 12C corresponding to the multiple DC-to-DC converters 1A to 1C, respectively.

In step S07, the control device 30 corrects at least one voltage detector 12 from among the voltage detectors 12A to 12C, based on the detected values of the voltage detectors 12A to 12C. In S07, the control device 30 estimates the true value of the stepped-up voltage in the bidirectional chopper 10 of the DC-to-DC converter 1 (first DC-to-DC converter) by comparing the detected values of the voltage detectors 12A to 12C. The control device 30 then corrects at least one voltage detector 12 using the estimated true value of the stepped-up voltage.

As described above, according to the present embodiment, the voltage detectors 12, which are disposed in the battery system 100 that is configured including multiple step-up circuits (bidirectional choppers 10) that are connected in parallel, can be corrected.

In the droop control of the DC-to-DC converter 1, the stepped-up voltage of the bidirectional chopper 10 (step-up circuit) is detected by the voltage detector 12, and the electric power that is charged to and discharged from the corresponding battery pack B is controlled such that the detected value of this voltage detector 12 matches the target voltage. In the droop control, detection errors of the voltage detectors 12 lead to errors in the electric power that is charged to and discharged from the battery pack B. Accordingly, in the battery system 100, a wiring design that anticipates this error in electric power is necessary. There is concern that the wiring may become large in size, since the wiring such as the power line L or the like is designed in anticipation of increase in electric power due to detection errors of the voltage detectors 12.

According to the present disclosure, the detection errors of the voltage detectors 12 are reduced by correcting the voltage detectors 12, and accordingly errors in the electric power charged to and discharged from the battery pack B are suppressed. As a result, there is no need to increase the scale of the wiring in the wiring design of the battery system 100.

The embodiment disclosed herein should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A battery system regarding which charging and discharging between the battery system and an external system is performed, the battery system comprising:
a plurality of battery packs connected the external system, in parallel to each other;
a plurality of DC-to-DC converters provided corresponding to the battery packs respectively, each of which performs direct current voltage conversion between a corresponding battery pack and the external system; and
a control device that controls the DC-to-DC converters, wherein
each of the DC-to-DC converters includes
a step-up circuit that steps up direct current voltage of the corresponding battery pack and outputs a stepped-up voltage, that is voltage after stepping up, to the external system, and
a voltage detector for detecting the stepped-up voltage;
the battery system is configured to execute a normal operation mode in which charging and discharging is performed between the battery system and the external system, and a correction mode in which the voltage detector is corrected,
in the normal operation mode, the control device controls the step-up circuit for each of the DC-to-DC converters using a detected value of the voltage detector, and
in the correction mode, the control device
controls the step-up circuit of a first DC-to-DC converter that is selected from the DC-to-DC converters, while stopping operation of the step-up circuits of the remaining DC-to-DC converters, and
during control of the step-up circuit of the first DC-to-DC converter, corrects the voltage detector of at least one DC-to-DC converter from among the DC-to-DC converters, based on the detected values of the voltage detectors of the DC-to-DC converters.

2. The battery system according to claim 1, wherein:
during control of the step-up circuit of the first DC-to-DC converter, the control device
estimates a true value of the stepped-up voltage in the step-up circuit of the first DC-to-DC converter based on the detected values of the voltage detectors of the DC-to-DC converters, and
uses the true value that is estimated to correct the voltage detector of the at least one DC-to-DC converter.

3. The battery system according to claim 1, wherein:
the external system includes a power conversion device that performs bidirectional electric power conversion between a power grid and the battery system, and
the control device executes the correction mode during shutdown of the power conversion device.

4. The battery system according to claim 1, wherein, in the normal operation mode, the control device executes droop control of the step-up circuit in each of the DC-to-DC converters, based on the detected value of the voltage detector.
